(19) United States
(12) Patent Application Publication
(10) Pub. No.: US 2026/0051845 A1
(43) Pub. Date: Feb. 19, 2026

(54) RAIL MOUNTABLE JUNCTION BOX

(71) Applicant: Unirac, Inc., Albuquerque, NM (US)

(72) Inventor: Shawn Meine, Phoenix, AZ (US)

(73) Assignee: Unirac, Inc., Albuquerque, NM (US)

(21) Appl. No.: 18/806,512

(22) Filed: Aug. 15, 2024

(51) Int. Cl. H02S 40/34; F16B 2/12

(52) U.S. Cl. CPC H02S 40/34; F16B 2/12

(57) ABSTRACT

A junction box includes a body configured to mount to a solar panel mounting rail, and a lid sized to seal against the body and to hingedly connect with the body when at a first angle that is less than a detaching angle. The lid is configured to separate from the body when at a second angle that is greater than the detaching angle.

### BACKGROUND

Electrical junction boxes are configured to house electrical components including wires, electrical connection joints, or other electrical system componentry. Electrical junction boxes may be configured for use indoors or outdoors. Whether used indoors or outdoors, electrical junction boxes must be securely fixed in a stationary position to prevent inadvertent exposure of sensitive electrical components.

Electrical junction boxes configured for use outdoors are generally attached directly to an outside surface (e.g., a roof, a wall, etc.). Depending on the attachment method, it may not be ideal for an electrical junction box to be attached to an outside surface. For example, some attachment methods may require penetrating the outside surface (e.g., screws, nails, etc.), which results in compromising the integrity of an otherwise weather-resistant and/or weatherproof exterior surface. Other attachment methods may require the use of chemicals and/or adhesives (e.g., glue, epoxy, etc.), which may cause damage to the outside surface itself, and may degrade over time which may require routine application of additional chemicals and/or adhesive.

Regardless of the attachment method, electrical junction boxes attached directly to outside surfaces still suffer from the inability to be easily relocated, replaced, or reoriented. For example, an exterior electrical system with junction boxes glued to a roof may not be easily removed or reconfigured without causing damage to the roof. Accordingly, improvements to junction boxes and junction box installation are necessary.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1A illustrates a top, front-side-looking perspective view of a rail mountable junction with a clamp mechanism, according to an embodiment of this disclosure.

FIG. 1B illustrates a top view of the rail-mountable junction box of FIG. 1A, according to an embodiment of this disclosure.

FIG. 2 illustrates a front view of the rail-mountable junction box of FIG. 1A, according to an embodiment of this disclosure.

FIG. 3 illustrates a side view of the rail-mountable junction box of FIG. 1A, according to an embodiment of this disclosure.

FIG. 4 illustrates a top, rear-side-looking perspective view of a rail-mountable junction box of FIG. 1A, according to an embodiment of this disclosure.

FIG. 4A illustrates a top, front-side-looking perspective view of a rail-mountable junction box of FIG. 1A, with the lid removed and with no clamp mechanism installed, according to an embodiment of this disclosure.

FIG. 5 illustrates a top, front-side-looking perspective view of the rail-mountable junction box of FIG. 1A, attached to a rail, according to an embodiment of this disclosure.

FIG. 6 illustrates a rear, side-looking perspective, partial cross-sectional view of the rail-mountable junction box of FIG. 1A, taken at line 6-6, according to an embodiment of this disclosure.

FIG. 7 illustrates another rear, side-looking perspective, partial cross-sectional view of the rail-mountable junction box of FIG. 1A with the clamp fastener removed, taken at line 7-7, according to an embodiment of this disclosure.

FIG. 7A illustrates the view of FIG. 7, with the lower clamp member and clamp fastener removed, according to an embodiment of this disclosure.

FIG. 8 illustrates another rear, side-looking perspective partial cross-sectional view of the rail-mountable junction box of FIG. 1A, taken at line 8-8, according to an embodiment of this disclosure.

FIG. 9 illustrates another rear, side-looking perspective partial cross-sectional view of the rail-mountable junction box of FIG. 1A, taken at line 9-9, according to an embodiment of this disclosure.

FIG. 10 illustrates a top, front-side-looking perspective view of a rail-mountable junction box with another clamping mechanism, attached to a rail, according to an embodiment of this disclosure.

FIG. 11 illustrates a top, front-side-looking perspective view of a rail-mountable junction box with another clamping mechanism, attached to a rail, according to an embodiment of this disclosure.

FIG. 12 illustrates a top, front-side-looking perspective view of a rail-mountable junction box with another clamping mechanism, attached to a rail, according to an embodiment of this disclosure.

FIG. 13 illustrates a top, front-side-looking perspective view of a rail-mountable junction box with another clamping mechanism, attached to a rail, according to an embodiment of this disclosure.

FIG. 14 illustrates a top, front-side-looking perspective view of a rail-mountable junction box with another clamping mechanism, attached to a rail, according to an embodiment of this disclosure.

FIG. 15 illustrates a top, front-side-looking perspective view of a rail-mountable junction box with another clamping mechanism, attached to a rail, according to an embodiment of this disclosure.

### DETAILED DESCRIPTION

This disclosure is directed to a junction box configured to mount directly to photovoltaic (PV) component mounting rails. More specifically, the disclosure describes embodiments of a rail-mountable junction box that may be easily installed, removed, and relocated, as well as embodiments of a rail-mountable junction box with a hinging lid that is easily removable.

In an embodiment, the rail-mountable junction box may include a lid, a base configured to mount to a PV component mounting rail, and a clamp mechanism configured to mount the base to the mounting rail. It is understood that there are multiple methods by which the base may be mounted to a rail. Accordingly, it is understood that in an embodiment, a base and a clamping mechanism may be specifically configured for a specific mounting method.

In an embodiment, the lid may be formed with plastic, resin, or any other suitable material and may be shaped to pivotally seat with a top edge of the base such that a weather-resistant and/or weatherproof seal is created between the lid and the base, when closed, with or without the use of a gasket or gasket material between the lid and the base.

In an embodiment, the lid may include a lid lock portion and a hinge portion. The lid lock portion of the lid may be configured to connect the lid in a securable manner to the base. For example, in an embodiment, the lid may be secured to the base via a fastener that passes through an aperture in a flange that extends from an edge of the lid at the lid lock portion and connects with the base (described further below). The hinge portion may be configured to pivotally connect the lid to a pivot point of the base. For example, in an embodiment, the hinge portion of the lid may include hinge protrusions. In an embodiment, the hinge protrusions may include at least an upper hinge tab and a lower hinge tab, each of which extends from an edge of the lid. The upper hinge tab and the lower hinge tab may be oriented proximate to each other to define between them a space as a hinge point whereby the lid may be pivoted for removal from, or placement on, the base. The space permits the upper hinge tab and the lower hinge tab to engage with the base.

In an embodiment, the hinge portion may be configured such that when the lid is raised to an angle of approximately 20 degrees with respect to a horizontal plane at the top of the body (e.g., a detachment angle), the hinge portion may be disengaged from the body and the lid may be lifted and completely removed from the body. It is understood that the hinge portion may be configured for the detachment angle to vary depending on the application. For example, in certain circumstances it may be advantageous for the detachment angle to be greater than, or less than 20 degrees.

In an embodiment, the base may be formed with plastic, resin, or other suitable material and may be configured to mount to a PV system mounting rail. The base may include one or more bosses or holes within the body (e.g., side walls and/or bottom wall of the box forming the base) thereof to accommodate mounting one or more of various components (e.g., grounding bus bar, wires, DIN rail, etc.). In an embodiment, the base may further include a base lock portion and a rail mounting portion. The base lock portion may include a lid support protrusion having an aperture that is positioned to align with the aperture within the flange of the lid lock portion of the lid, and that is sized to receive the fastener therethrough. In an embodiment, the fastener may be retainably inserted through the lid lock portion of the lid to avoid loss, and to be quickly aligned with the base lock portion of the base.

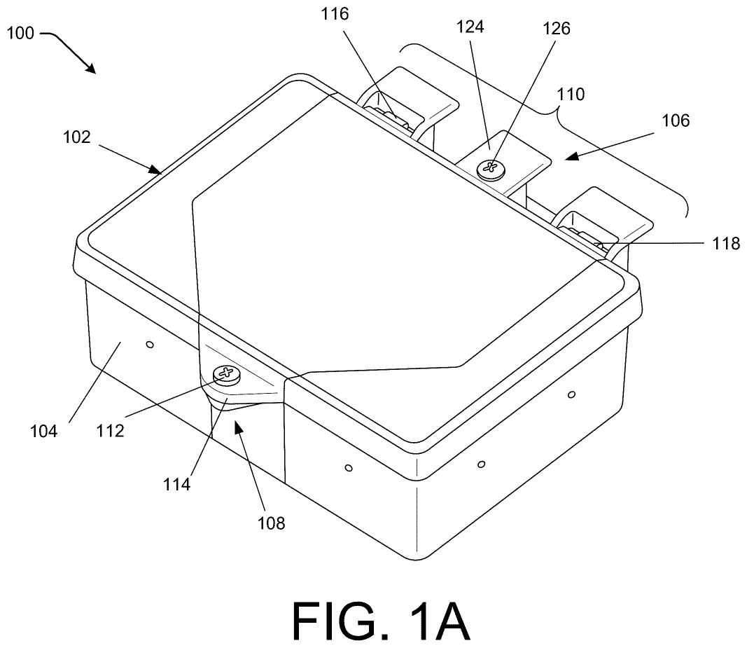

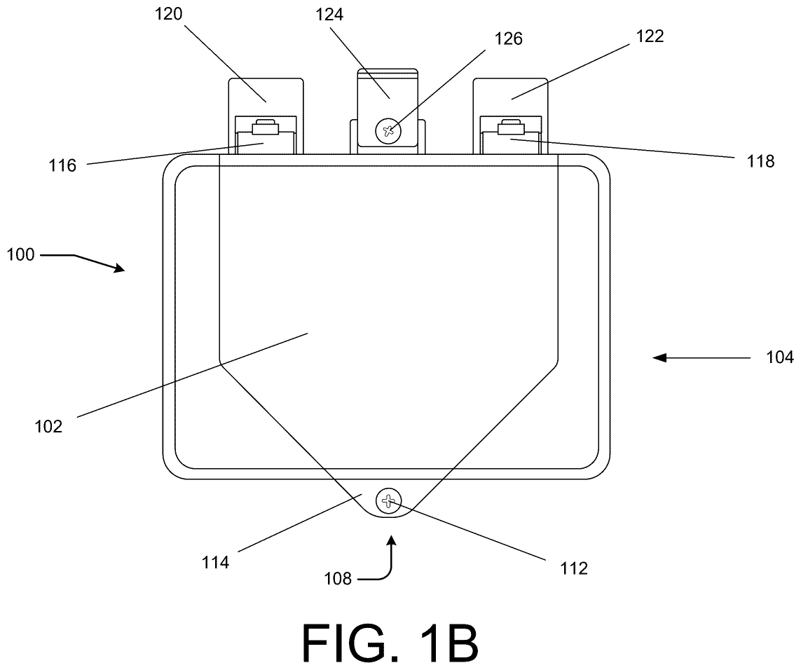

Turning to the drawings, FIGS. 1A and 1B illustrate a rail-mountable junction box 100 (“junction box 100”) including a lid 102, a base 104, and a clamp mechanism 106.

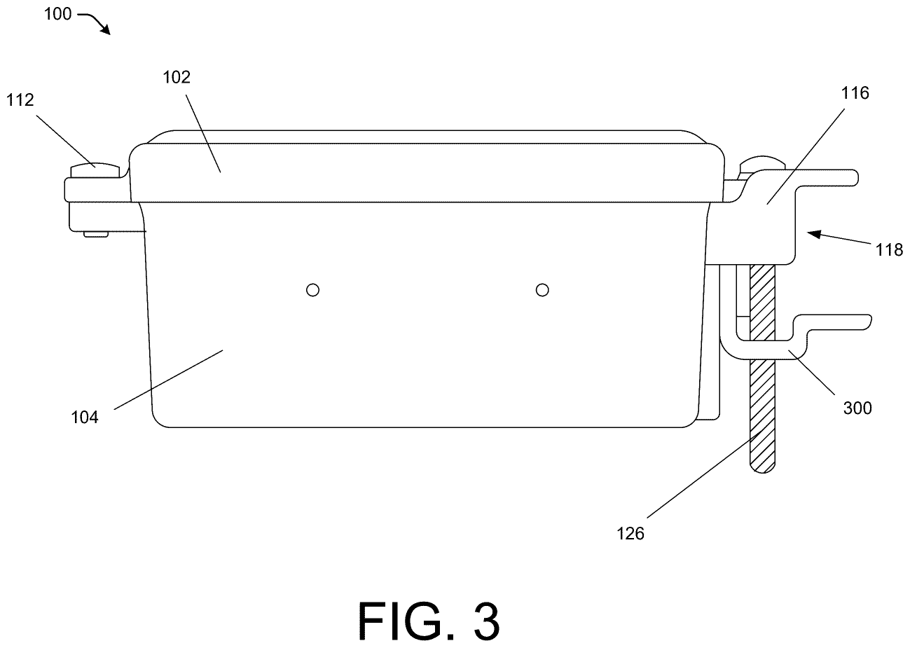

In an embodiment, lid 102 may include a lid lock portion 108 and a hinge portion 110. The lid lock portion 108 may include a lid fastener 112 (e.g., a bolt, screw, etc.) and a lid fastening protrusion 114, such as a protruding flange that extends away from a main body of the lid 102 (i.e., outward of the seat between the lid 102 and the base 104). The hinge portion 110 may include a first hinge 116 and a second hinge 118. In an embodiment, the base 104 may include a first mounting protrusion 120 and a second mounting protrusion 122. Moreover, in an embodiment, the clamp mechanism 106 may include an upper clamp portion 124, a clamp fastener 126, and a lower clamp portion 300 (not shown in FIG. 1A or 1B, but see reference number 300 in FIG. 3).

It is understood that in embodiments, the base 104 may include a rail mount (e.g., block body 406, the first mounting protrusion 120 and a second mounting protrusion 122) that may be in integral part to the base 104 and that the rail mount may be configured to engage with a mounting rail. In these embodiments, the rail mount may include protrusions (e.g., one/first protrusion, two/second protrusions, etc.) and/or many surfaces (e.g., one/first surface, two/second surfaces, etc.) configured to make and/or maintain contact with the mounting rail (e.g., a first protrusion may include a first surface configured to rest horizontally on a top surface of a mounting rail). It is also understood that the rail mount may be configured to be used, with an attachment device (e.g., the clamp mechanism 106, mounting bracket 1006 and mounting knob 1004, etc) directly (e.g., the clamp mechanism 106 may be configured to interact with the block body 406) or indirectly (i.e., the first mounting protrusion 120 and/or a second mounting protrusion 122 may position the base 104 on the rail for mounting).

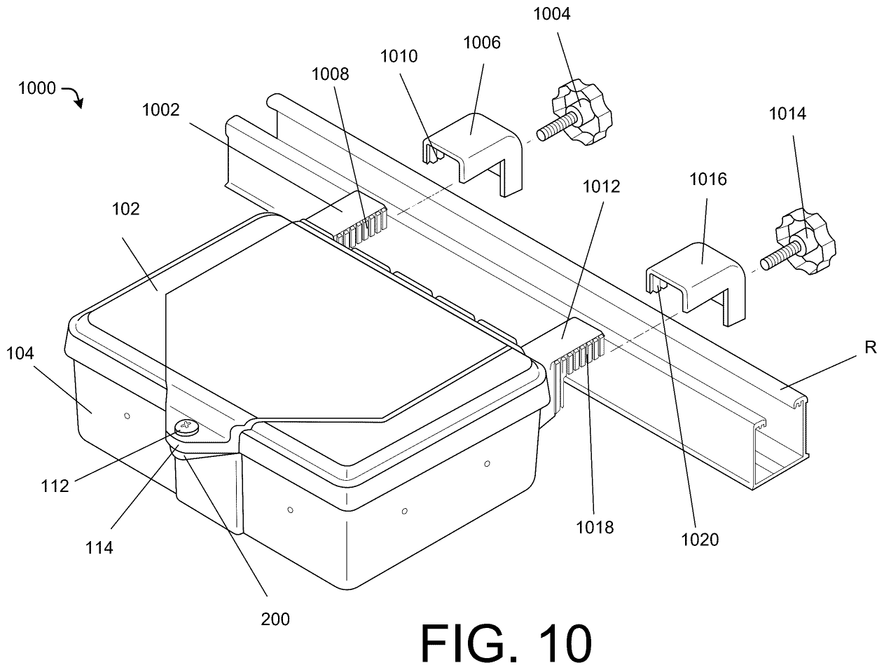

In an embodiment, the lid fastening protrusion 114 includes an aperture configured to receive the lid fastener 112 (the “aperture” is not visible in the figures, as the lid fastener 112 is shown extending therethrough). Alternatively, instead of utilizing lid fastener 112, it is understood that lid 102 may include a different fastening mechanism (e.g., latch, clip, etc.). In such embodiments, the lid fastening protrusion 114 may be shaped to accommodate the different fastening mechanisms (i.e., the fastening mechanism may be sized to provide operational clearances, etc.). In an embodiment, the hinge portion 110 of lid 102 may be disposed opposite the lock portion of the lid. It is understood that in an embodiment, the clamp mechanism 106 depicted in FIGS. 1A, 1B, 3, 4, 5, 6, 7, 8, and 9 may alternatively be replaced with one of the respective clamping mechanisms depicted in FIGS. 10-15 (discussed hereinafter).

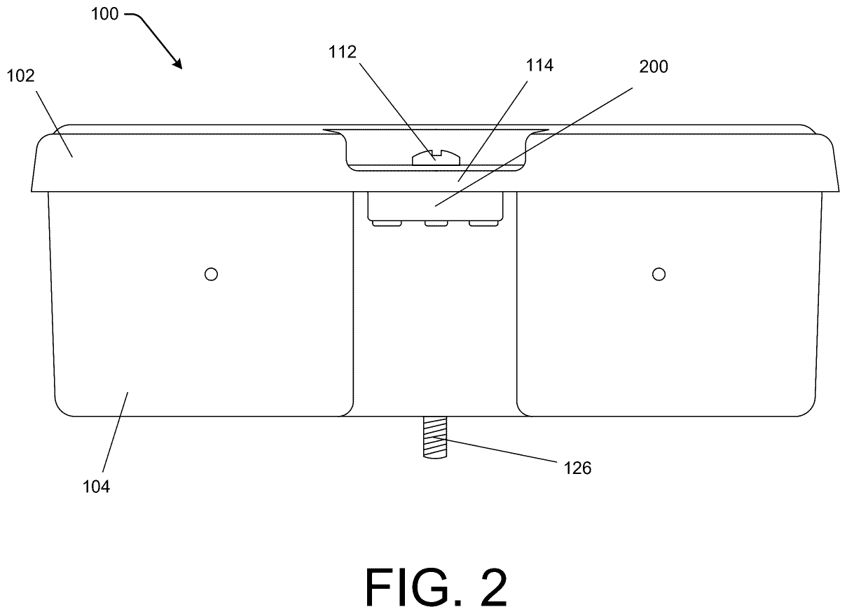

FIG. 2 illustrates a front view of the rail-mountable junction box 100 of FIG. 1A, according to an embodiment of this disclosure. In an embodiment, when seated upon the base 104, the lid 102 may extend over the base 104 (i.e., the lid 102 extends over the upper portion of the base 104). In an embodiment, the base 104 may include a body fastening protrusion 200. In an embodiment, the body fastening protrusion 200 may be shaped to compliment the shape of lid fastening protrusion 114 (i.e., the shape of the body fastening protrusion 200 may be symmetrical to the lid fastening protrusion 114). In an embodiment, the body fastening protrusion 200 may include an aperture configured to align with an aperture within the lid fastening protrusion 114 in order for the lid fastener 112 to pass through both fastening protrusions (114, 200). In an embodiment, the body fastening protrusion 200 may be configured to engage with the lid fastener 112 (i.e., the aperture within the body fastening protrusion 200 may be threaded and/or the aperture within the body fastening protrusion 200 may be configured to receive hardware that is threaded).

In an embodiment, the lid fastener 112 may extend only long enough to extend just beyond a lock portion of the base 104. It is understood that lid fastener 112 may have any length as required. Likewise, in an embodiment, clamp fastener 126 may extend just past the base 104, however, it is understood that clamp fastener 126 may have any length as desired to connect to a mounting rail.

FIG. 3 illustrates a side view of the rail-mountable junction box 100 of FIG. 1A, according to an embodiment of this disclosure. In an embodiment, the clamping mechanism 106 may include an upper clamp portion 124, a lower clamp portion 300, and a clamp fastener 126. In an embodiment, base 104 may be configured to receive upper clamp portion 124 and lower clamp portion 300. In an embodiment, upper clamp portion 124 and lower clamp portion 300 may be configured to allow clamp fastener 126 to extend through upper clamp portion 124 and lower clamp portion 300 (i.e., upper clamp portion 124 and lower clamp portion 300 may each include an aperture sized appropriately to allow clamp fastener 126 to pass therethrough). In an embodiment, lower clamp portion 300 may include an aperture that is configured to engage with clamp fastener 126 (i.e., the aperture within the lower clamp portion 300 may be threaded). In an embodiment, the rotation of the clamp fastener 126 while extending through the upper clamp portion 124 and lower clamp portion 300 may cause the distance between the upper clamp portion 124 and the lower clamp portion 300 to change (i.e., rotating the clamp fastener 126 clockwise may cause the lower clamp portion 300 to raise and decrease the distance between the upper clamp portion 124 and the lower clamp portion 300, and vice versa).

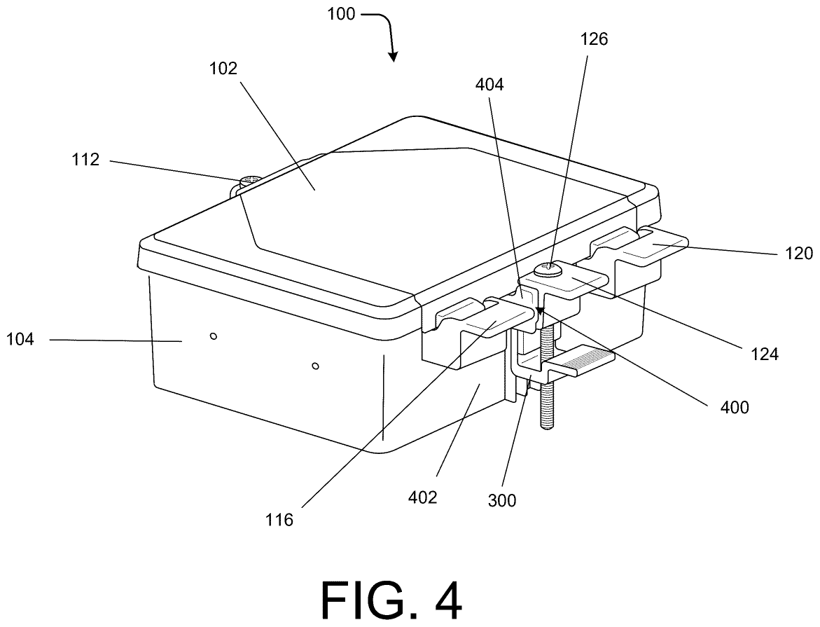

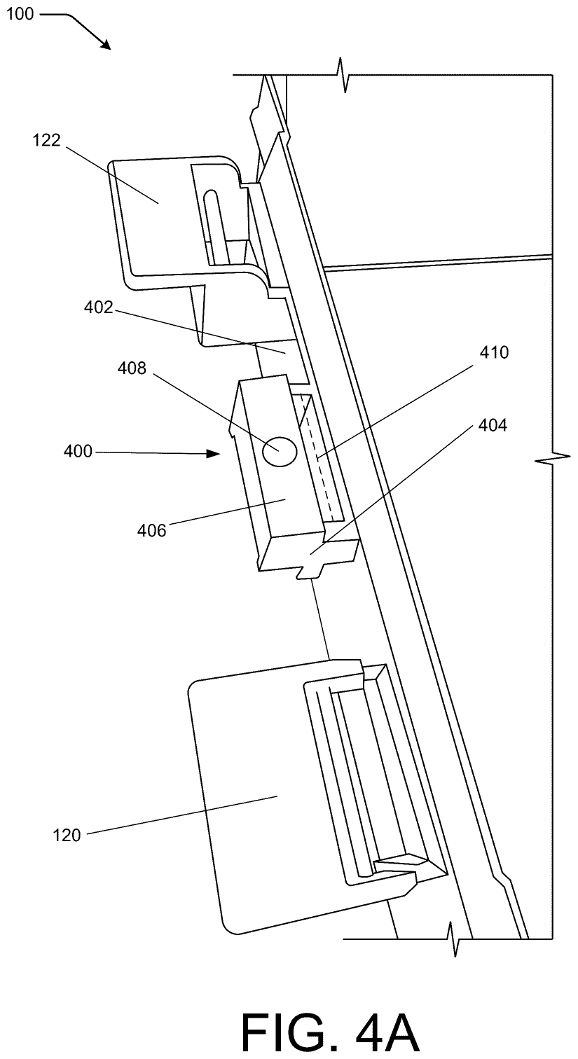

FIG. 4 illustrates a top, rear-side-looking perspective view of a rail-mountable junction box 100 of FIG. 1A, according to an embodiment of this disclosure. In an embodiment, base 104 may include a box clamp support 400. In an embodiment, upper clamp portion 124 may be shaped to rest on and engage with box clamp support 400. For example, box clamp support 400 may include a block body (not shown in FIG. 4, but see reference number 406 in FIG. 4A) having a rectangular prism shape that is held offset from the rear wall 402 of the base 104 by wings 404 (one wing shown in FIG. 4, and the other wing is symmetrical and hidden in FIG. 4, supporting the opposite side of the block body as seen in FIG. 4A).

In an embodiment, the upper clamp portion 124 may be configured to fit over and rest on block body 406 of box clamp support 400 and between the wings 404, as shown in FIG. 4. More details of the box clamp support 400 are provided as discussed with respect to FIG. 4A.

FIG. 4A illustrates a top, rear-side-looking perspective view of a rail-mountable junction box 100 of FIG. 1A, according to an embodiment of this disclosure. In an embodiment, base 104 may include a box clamp support 400. Box clamp support 400 may include a block body 406 having a rectangular prism shape that is held offset from the rear wall 402 of the base 104 by wings 404 (one wing shown in FIG. 4, and the other wing is symmetrical and hidden in FIG. 4, supporting the opposite side of the block body 406). Block body 406 may include an aperture 408 extending through the block body 406 sized to accommodate the clamp fastener 126. In other words, box clamp support 400 may be integrally formed with the base 104 including a pair of symmetrically positioned, spaced-apart wings 404, extending away from the rear wall of the base 104 and integrally supporting therebetween the block body 406, such that a slot 410 exists between the block body 406 and the rear wall 402 of the base 104.

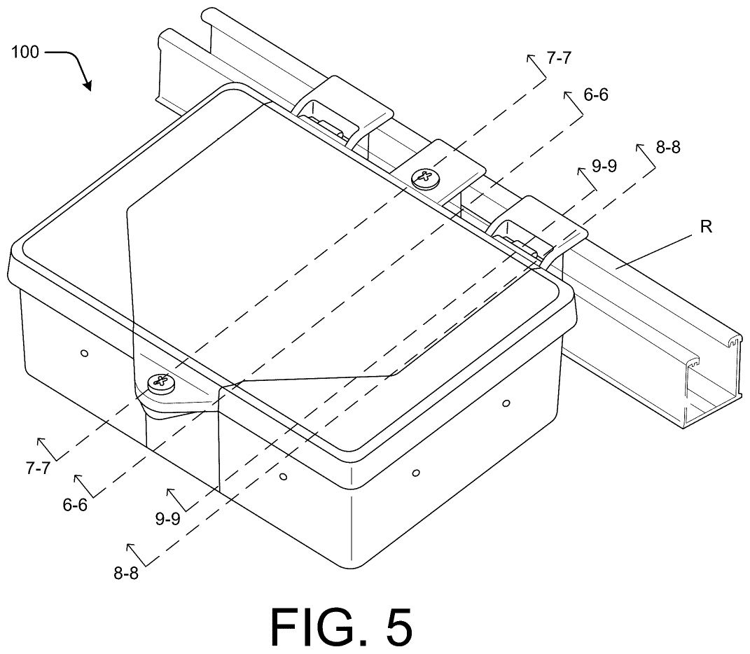

FIG. 5 illustrates a top, front-side-looking perspective view of the rail-mountable junction box 100 of FIG. 1A, according to an embodiment of this disclosure, with the rail-mountable junction box further attached to a rail (R).

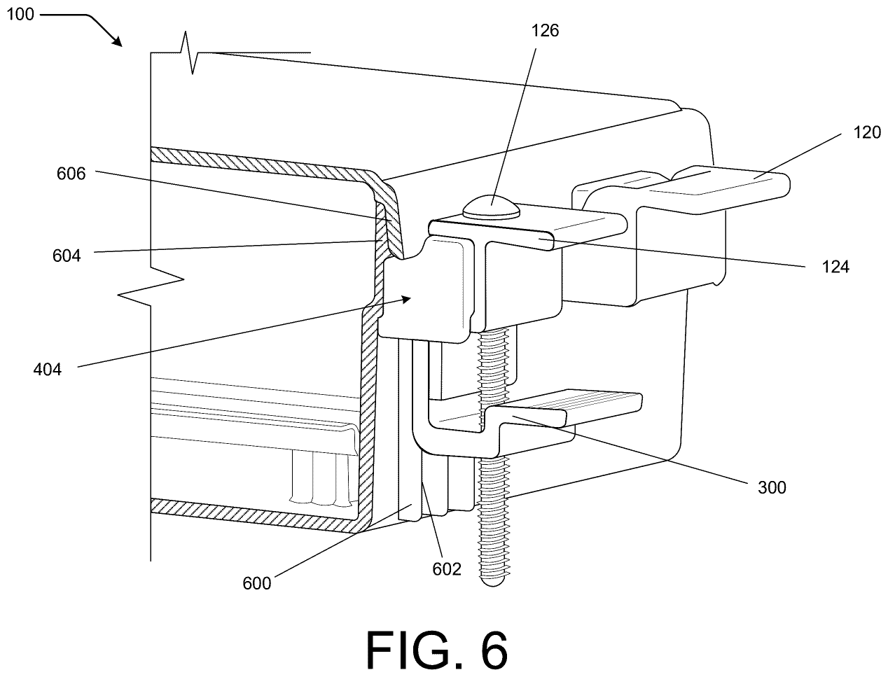

FIG. 6 illustrates a rear, side-looking perspective, partial cross-sectional view of the rail-mountable junction box 100 of FIG. 1A, taken at line 6-6, according to an embodiment of this disclosure. In an embodiment, junction box 100 may include a plurality of ribs 600, extending vertically in length, that assist a user in aligning the lower clamp portion 300, and support the clamp mechanism 106. In an embodiment, ribs 600 may protrude from the base 104 and may extend vertically from the bottom of base 104 to the box clamp support 400. In an embodiment, an edge 602 of the respective ribs 600 engages, via resting contact, with lower clamp portion 300 in order to align and support the lower clamp portion 300, thereby reducing a risk of the lower clamp portion 300 being deflected away from its non-clamped position (i.e., the side wall of the lower clamp may be parallel with the rear wall 402). After aligning the lower clamp portion 300 to engage with the box clamp support 400 and the upper clamp portion 124, the clamp fastener 126 may be actuated to attach the junction box 100 to a mounting rail.

In an embodiment, junction box 100 may include a base 104 that has a lid seating surface 604, and a lid 102 that has a base seating surface 606. The lid seating surface 604 may have a lower portion that is flared out in a direction that extends away from the base 104. The lid seating surface 604 may also include a top edge that is configured to support the lid 102. The base seating surface 606 may include a lower portion that is sloped downward and angled away from the lower portion of the lid seating surface 604. It is noted that the lower portion of the base seating surface 606 is configured to match the angle of the flared lower portion of the lid seating surface 604 such that the lower portion of the lid seating surface 604 and the lower portion of the base seating surface 606 may planarly engage with each other. Similarly, the upper portion of the base seating surface 606 may be configured to engage with and rest upon the top edge of the lid seating surface 604. In an embodiment, the lid seating surface 604 and the base seating surface 606 may be configured to, when closed, closely engage with each other to create a weather-resistant and/or weatherproof seal without the use of a gasket.

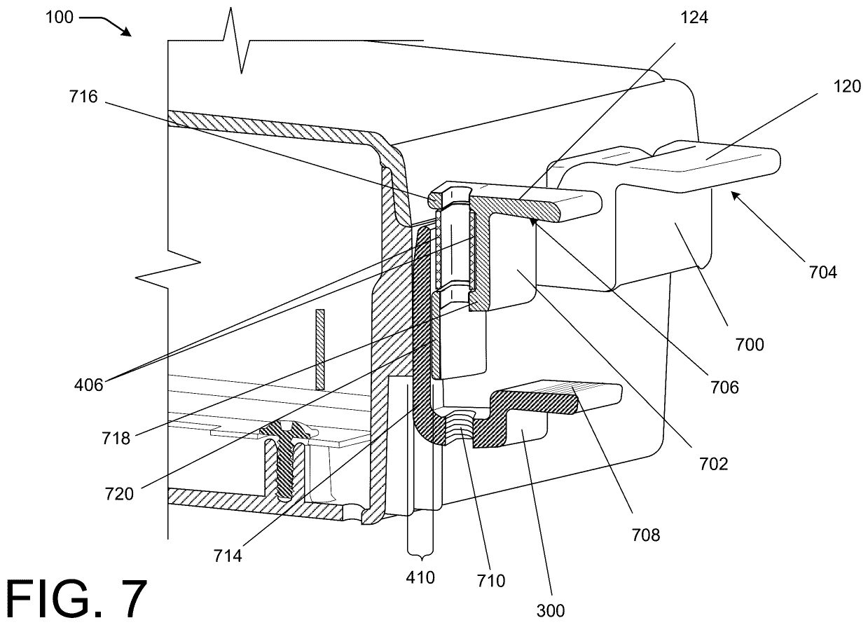

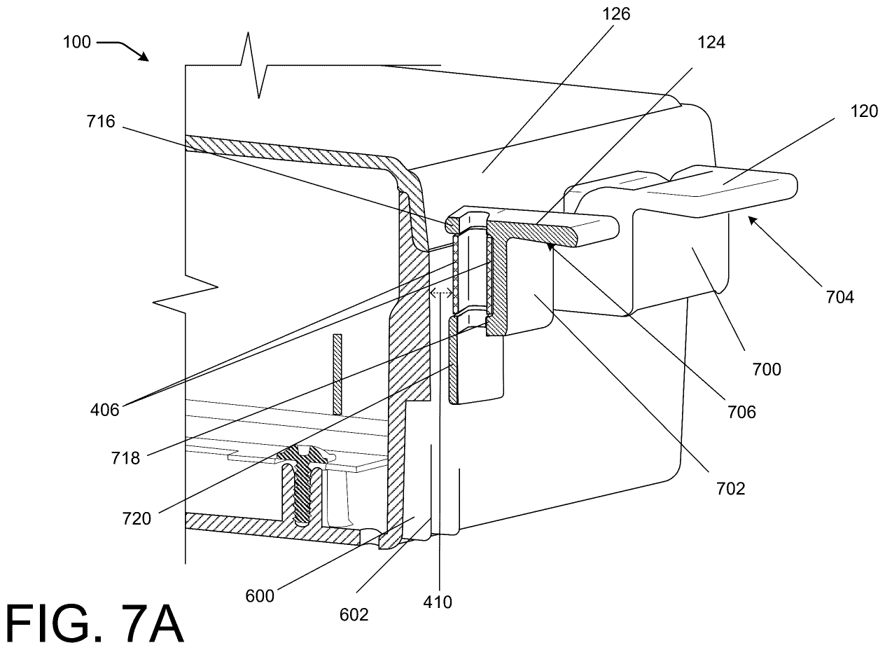

FIG. 7 illustrates another rear and side-looking perspective, partial cross-sectional view of the rail-mountable junction box 100 of FIG. 1A with the claim fastener 126 removed, taken at line 7-7, according to an embodiment of this disclosure. Note, though not shown in FIG. 7, inasmuch as the structure of the second mounting protrusion 122 may be identical, or substantially similar, to that described with respect to the first mounting protrusion 120, the details below are described with respect to the first mounting protrusion 120 as depicted.

In an embodiment, the first mounting protrusion 120 and upper clamp portion 124 may each include a first surface (700, 702) (i.e., a rail support surface) that extends vertically to contact a side of a mounting rail, upon installation. In an embodiment, the first mounting protrusion 120 and the upper clamp portion 124 may each further include a second surface (704, 706) that extends laterally to rest via contact on a top surface of a mounting rail, upon installation. In an embodiment, a portion of the second surfaces (704, 706) may be textured to increase friction between the second surfaces (704, 706) and the top surface of a mounting rail (e.g. one or more rows of teeth, diamond pattern, criss-crossed lines, etc.). In an embodiment, first mounting protrusion 120 and upper clamp portion 124 may be oriented such the first surfaces (700, 702) may occupy the same vertical plane. Likewise, in an embodiment, first mounting protrusion 120 and upper clamp portion 124 may be oriented such that the second surfaces (704, 706) may occupy the same horizontal plane.

As indicated above, in an embodiment, box clamp support 400 may include a slot 410 between the base 104 and the block body 406, sized to receive a vertical arm 714 of the lower clamp portion 300. The upper clamp portion 124 may include an area configured to receive the box clamp support 400 that is substantially C-shaped and defined by upper ledge 716, the first surface 702, and lower ledge 718. The upper ledge 716 and the lower ledge 718 of upper clamp portion 124 may each include an aperture sized to accommodate the clamp fastener 126 (the “apertures” for the upper and lower ledges (716, 718) are not visible in FIGS. 3, 4, 6, 8, and 9 as the clamp fastener 126 passes through the apertures, however, the “apertures” are partially visible in FIGS. 7 and 7A as the clamp fastener 126 removed). Additionally, block body 406 may include an aperture 408 that extends vertically through the block body 406 (the aperture 408 is visible in FIG. 4A, but only partially visible in FIGS. 7 and 7A as the clamp fastener 126 is removed). When the upper clamp portion 124 is installed on the block body 406, the aperture within the upper and lower ledges (716, 718) may be configured to align with the aperture 408 extending through the block body 406 such that clamp fastener 126 may extend through the upper ledge 716, the block body 406, and the lower ledge 718. When installed on the block body 406, a vertical arm 720 of the the upper clamp portion 124 may extend parallel to the alignment ribs 600 to create a gap adjacent to the slot 410 wherein the gap is sized similar to the slot 710 and configured to accommodate the thickness of the vertical arm 714.

In an embodiment, the lower clamp portion 300 may also include a clamping surface 708 configured to tighten against the bottom side of the mounting rail. In an embodiment, the clamping surface 708 may be textured (e.g. one or more rows of teeth, diamond pattern, criss-crossed lines, etc.). The lower clamp portion 300 may include an aperture 710 (aperture 710 for the lower clamp portion 300 is not visible in FIGS. 3, 4, 6, 8, and 9 as the clamp fastener 126 passes through the aperture, however the aperture 710 is partially visible in FIG. 7 as the clamp fastener 126 is removed) configured to align with the aperture 408 extending through the block body 406 and the upper clamp portion 124 such that clamp fastener 126 may extend through the upper ledge 716, the block body 406, the lower ledge 718, and the aperture within the lower clamp portion 300. The aperture 710 within the lower clamp portion 300 may be configured to engage with the clamp fastener 126 (i.e., the aperture 710 in the lower clamp portion 300 may be threaded). Rotating the clamp fastener 126 while it is engaged with the upper clamp portion 124, the box clamp support 400, and the lower clamp portion 300, will draw the lower clamp portion 300 to the upper clamp portion 124. In the example, the second surface 706 of the upper clamp portion 124 and the clamping surface 708 of the lower clamp portion 300 may tighten against the mounting rail.

When the lower clamp portion 300 is installed, the vertical arm 714 may contact the edge 602 of the alignment ribs 600 and the vertical arm 720 of the upper clamp portion 124 while extending through the slot 410. In an embodiment, the lower clamp portion 300 may be raised or lowered while maintaining contact with the edge 602 of the alignment ribs 600 and the vertical arm 720 of the upper clamp portion 124 which will decrease or increase, respectively, the distance between the second surface 706 of the upper clamp portion 124 and the clamping surface 708 of the lower clamp portion 300.

FIG. 7A illustrates the same view of the rail-mountable junction box 100 of FIG. 1A as depicted in FIG. 7, with the lower clamp member 300 removed, according to an embodiment of this disclosure. Insofar as FIG. 7A is an alternative view of the rail-mountable junction box 100 of FIG. 1A as depicted in FIG. 7 with the lower clamp member 300 removed, the applicable components and descriptions listed in FIG. 7A are similar to the components listed and discussed above with regard to FIG. 7.

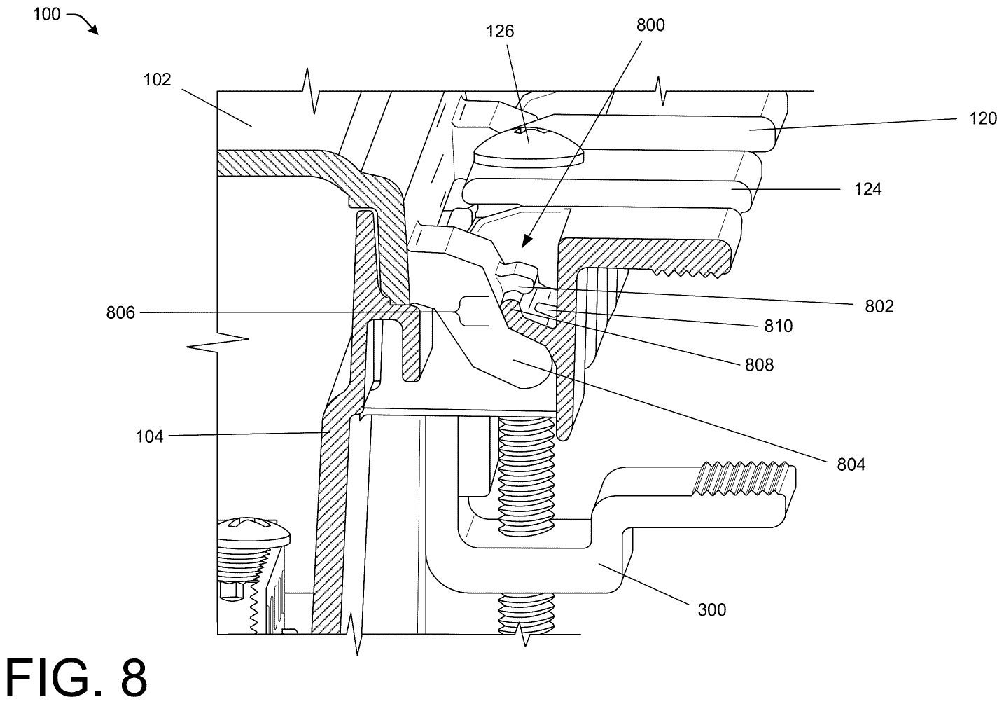

FIG. 8 illustrates another rear, side-looking perspective partial cross-sectional view of the rail-mountable junction box 100 of FIG. 1A, taken at line 8-8, according to an embodiment of this disclosure. In an embodiment, the lid 102 may include a lid hinge 800 which may include an upper hinge tab 802 and a lower hinge tab 804. As depicted, the upper hinge tab 802 and lower hinge tab 804 extend in opposite directions so as to be separated by a gap 806. The base 104 may include a mounting tab 808 having a hole 810 centrally located and extending vertically through (or at least partially into) the mounting tab 808. In an embodiment, the mounting tab 808 may be configured to be received into the gap 806, such that one or more surfaces of the mounting tab 808 contact one or more surfaces of the upper hinge tab 802 and the lower hinge tab 804 in the region of the gap 806 therebetween. Moreover, the hole 810 accommodates the upper hinge tab 802 therein, when the lid 102 is rotated.

As indicated above, the surfaces bounding the gap 806 (i.e., the surfaces forming the upper hinge tab 802 and lower hinge tab 804) may be engaged (i.e., in frictional contact) with the outer surface of mounting tab 808 when the lid 102 is installed on the base 104. In an embodiment, when the lid 102 is raised, the surface engagement between the upper hinge tab 802 and the lower hinge tab 804 allows the lid 102 to pivot about the mounting tab 808. In an embodiment, when the lid 102 is raised to an angle above a threshold angle, (e.g., approximately 20 degrees), the upper hinge tab 802 and the lower hinge tab 804 will rotate around the mounting tab 808 such that the lid 102 may be lifted away from the base 104. In an embodiment, when the lid 102 is raised to an angle below a threshold angle, (e.g., less than approximately 20 degrees), the upper hinge tab 802 and the lower hinge tab 804 will remain engaged to the mounting tab 808 such that the lid 102 may not be lifted away from the base 104.

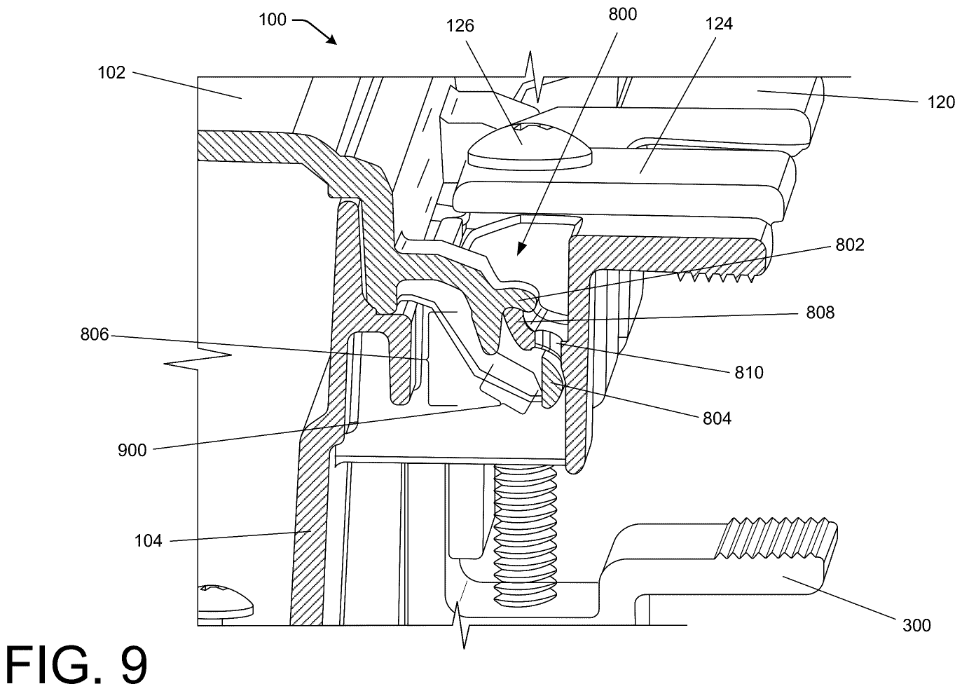

FIG. 9 illustrates another rear, side-looking perspective partial cross-sectional view of the rail-mountable junction box 100 of FIG. 1A, taken at line 9-9, according to an embodiment of this disclosure. As compared to the cross-section view in FIG. 8, the cross-section view of FIG. 9 more clearly demonstrates the interaction of the contact/engagement surfaces. In an embodiment, gap 806 may include a void 900 within the lower hinge tab 804. The void 900 may allow for reducing contact between the surfaces within the gap 806 and the surfaces of the mounting tab 808 when the lid 102 is being repositioned, installed, and/or removed.

FIG. 10 illustrates a top, front-side-looking perspective view of a rail-mountable junction box 1000 (“junction box 1000”) with another clamping mechanism attached to a rail, according to an embodiment of this disclosure. Junction box 1000 may include lid 102, base 104, lid fastener 112, lid fastening protrusion 114, and body fastening protrusion 200, similar to those in FIGS. 1A, 1B, and 2. Additionally, in an embodiment, junction box 1000 may further include a mounting system including components that work together to mount junction box 100 to a rail R. The manner of mounting junction box 1000 to the rail R may be achieved via a first mounting protrusion 1002 extending from base 104, in connection with a mounting knob 1004, a mounting bracket 1006, a first tongue and groove side surface 1008, and a second tongue and groove side surface 1010; and well as a second mounting protrusion 1012 extending from base 104, a second mounting knob 1014, a second mounting bracket 1016, a third tongue and groove side surface 1018, and a fourth tongue and groove surface 1020.

In an embodiment, the first mounting protrusion 1002 and the second mounting protrusion 1012 include a surface configured to clamp against the side of the mounting rail R. The first mounting protrusion 1002 and the second mounting protrusion 1012 may be configured to rest upon a top surface of the mounting rail R. In an embodiment, the first mounting protrusion 1002 and the second mounting protrusion 1012 include a first tongue and groove side surface 1008 and a third tongue and groove side surface 1018, respectively. Further, the first mounting bracket 1006 and the second mounting mounting bracket 1016 include an inside surface configured with a second tongue and groove surface 1010 and a fourth tongue and groove surface 1020, respectively. The first tongue and groove side surface 1008 is sized and shaped to interlock with the second tongue and groove surface 1016, and likewise, the third tongue and groove side surface 1018 is sized and shaped to interlock with the fourth tongue and groove surface 1020. In other words first mounting bracket 1006 is configured to slide onto first mounting protrusion 1002 and the first tongue and groove surfaces 1008 and second tongue and groove surfaces 1016 may be interlocked to prevent lateral movement between first mounting bracket 1006 and first mounting protrusion 1002).

Moreover, in an embodiment, the first mounting bracket 1006 and the first mounting knob 1004 may be configured to engage with first mounting protrusion 1002. In an embodiment, first mounting bracket 1006 and second mounting bracket 1016 may each have a threaded aperture configured to receive first mounting knob 1004 and second mounting knob 1014, respectively. In an embodiment, first mounting knob 1004 and second mounting knob 1014 may pass through first mounting bracket 1006 and second mounting bracket 1016, respectively, to tighten against mounting rail R.

For example, base 104 may be positioned on mounting rail R such that first mounting protrusion 1002 and second mounting protrusion 1012 rest upon the top rail of mounting rail R. In the example, first mounting bracket 1006 and first mounting knob 1004 and second mounting bracket 1016 and second mounting knob 1014 may be lowered onto first mounting protrusion 1002 and second mounting protrusion 1012, respectively. In the example, first mounting knob 1004 may be installed into first mounting bracket 1006 and first mounting protrusion 1002, and second mounting knob 1014 may be installed into second mounting bracket 1016 and second mounting protrusion 1012, so as to secure junction box 1000 to the mounting rail R.

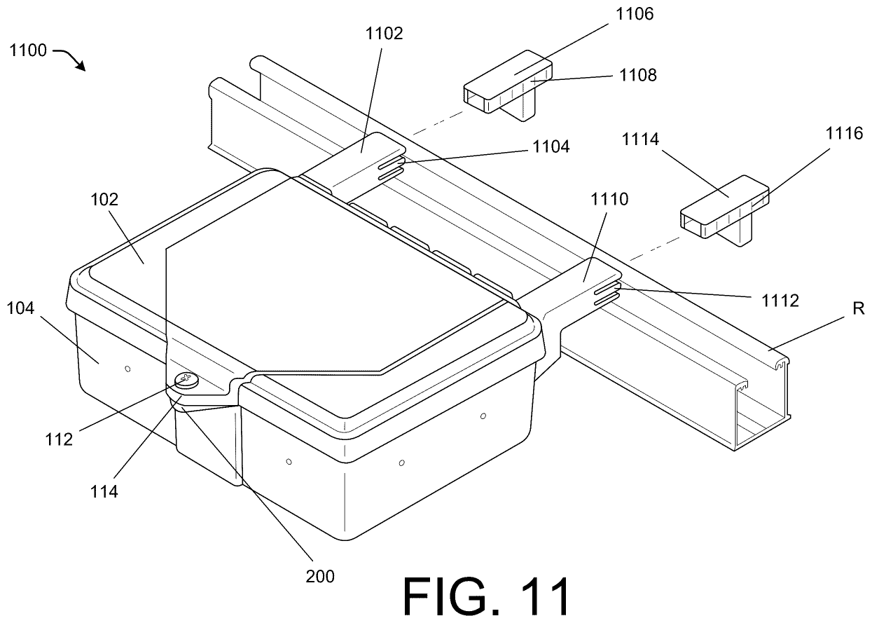

FIG. 11 illustrates a top, front-side-looking perspective view of a rail-mountable junction box (“junction box 1100”) with another alternative clamping mechanism, attached to a rail, according to an embodiment of this disclosure. Junction box 1100 may include lid 102, base 104, lid fastener 112, lid fastening protrusion 114, body fastening protrusion 200, along with a first mounting protrusion 1102 extending from base 104, first locking tabs 1104, a first mounting fastener 1106, and first mounting grooves 1108; as well as a second mounting protrusion 1110 extending from base 104, second locking tabs 1112, a second mounting fastener 1114, and second mounting grooves 1116.

In an embodiment, first mounting protrusion 1102 and second mounting protrusion 1110 include a surface configured to engage with the side of a mounting rail R. In an embodiment, first mounting protrusion 1102 and second mounting protrusion 1110 may include first locking tabs 1104 and second locking tabs 1112, respectively. First mounting protrusion 1102 and second mounting protrusion 1110 are configured to receive first mounting fastener 1106 and second mounting fastener 1114, respectively. In an embodiment, first mounting fastener 1106 and second mounting fastener 1114 may include first mounting grooves 1108 and second mounting grooves 1116, respectively. In an embodiment, first mounting protrusion 1102, first locking tabs 1104 and second mounting protrusion 1110 and second locking tabs 1112 are configured to engage with the first mounting grooves 1108 and second mounting grooves 1116, respectively, when first mounting fastener 1106 is inserted into mounting protrusion 1102 and when second mounting fastener 1114 is inserted into second mounting protrusion 1110. In an embodiment, first mounting fastener 1106 and second mounting fastener 1114 include a surface, respectively, to rest along a surface of a mounting rail R, opposite of base 104.

For example, base 104 may be positioned such that first mounting protrusion 1102 and second mounting protrusion 1110 rest upon the top surface of mounting rail R and rest against a first side surface of the mounting rail R. In the example, first mounting fastener 1106 and second mounting fastener 1114 are configured to be inserted into first mounting protrusion 1102 and second mounting protrusion 1110, respectively. In the example, first locking tabs 1104 and second locking tabs 1112 on first mounting protrusion 1102 and second mounting protrusion 1110, respectively, may engage with the first mounting grooves 1108 and second mounting grooves 1116 of first mounting fastener 1106 and second mounting fastener 1114, respectively. Further, first locking tabs 1104 and second locking tabs 1112 may engage with the first mounting grooves 1108 and second mounting grooves 1116 such that the first mounting fastener 1106 and the second mounting fastener 1114 may not be removed from the first mounting protrusion 1102 and mounting protrusion 1110 without first disengaging first locking tabs 1104 and second locking tabs 1112. In the example, first locking tabs 1104 and second locking tabs 1112 may be biased toward the center of first mounting protrusion 1102 and second mounting protrusion 1110, respectively. In the example, first locking tabs 1104 and second locking tabs 1112 must may be repositioned such that the tabs may disengage with first mounting grooves 1108 and second mounting grooves 1116 such that first mounting fastener 1106 and the second mounting fastener 1114 may be removed.

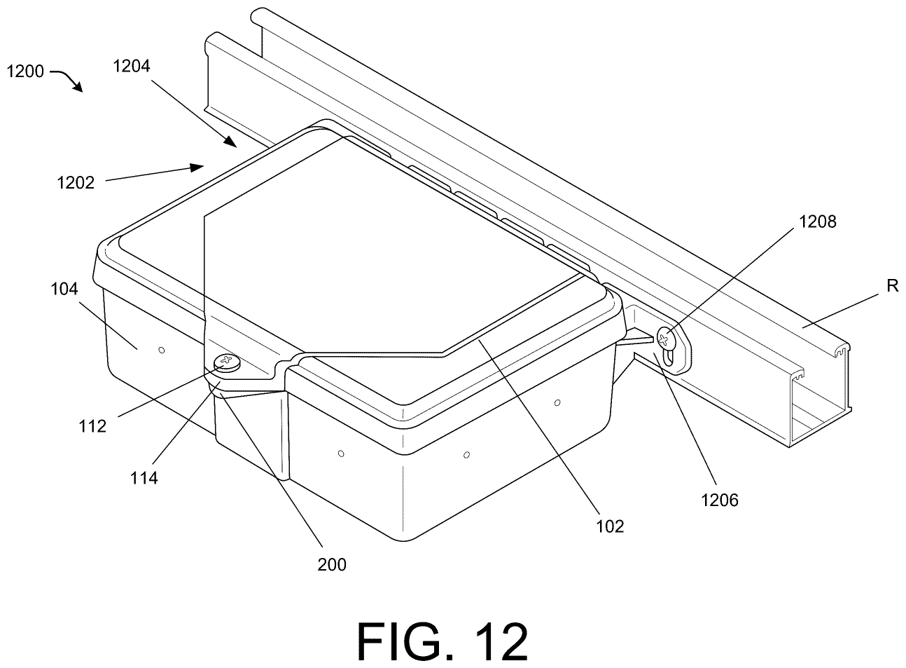

FIG. 12 illustrates a top, front-side-looking perspective view of a rail-mountable junction box 1200 (“junction box 1200”) with another clamping mechanism, attached to a rail, according to an embodiment of this disclosure. Junction box 1200 may include lid 102, base 104, lid fastener 112, lid fastening protrusion 114, body fastening protrusion 200, first mounting protrusion 1202 (not expressly shown, but see second mounting protrusion 1206, which is symmetrically designed to mirror first mounting protrusion 1202) extending from base 104, first mounting fastener 1204 (also not expressly shown, but see the second mounting fastener 1208, which is similar or identical to first mounting fastener 1204), and the corresponding second mounting protrusion 1206 extending from base 104 and second mounting fastener 1208.

In an embodiment, first mounting protrusion 1202 and second mounting protrusion 1206 are configured to planarly engage with the side of a mounting rail R. In an embodiment, first mounting protrusion 1202 and second mounting protrusion 1206 include respective apertures therein to receive first mounting fastener 1204 and second mounting fastener 1208. It is understood that the first and second mounting fasteners (e.g., 1204 and/or 1208, etc.) may be a screw, a bolt, or other suitable fastener.

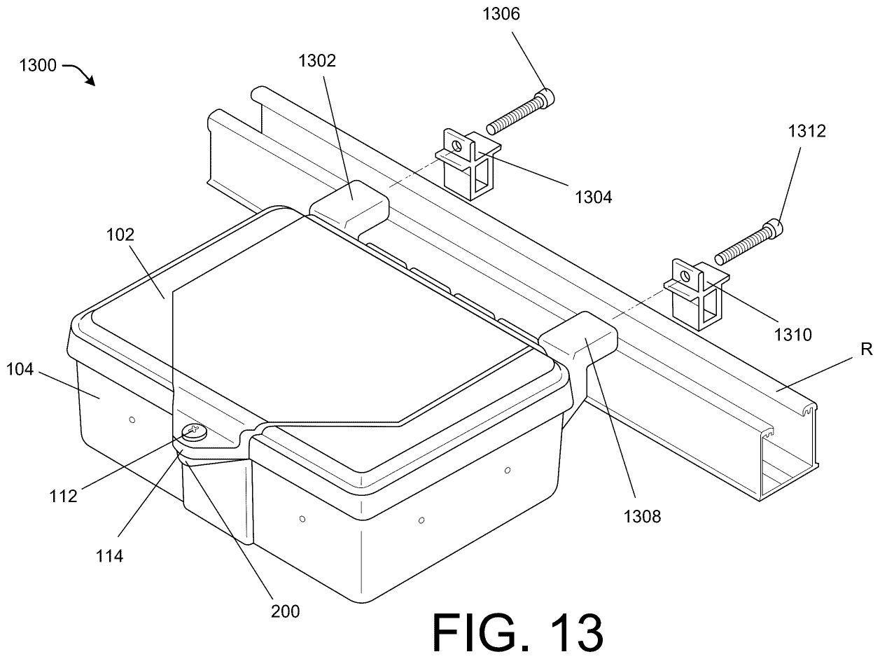

FIG. 13 illustrates a top, front-side-looking perspective view of a rail-mountable junction box 1300 (“junction box 1300”) with another clamping mechanism, attached to a rail, according to an embodiment of this disclosure. Junction box 1300 may include lid 102, base 104, lid fastener 112, lid fastening protrusion 114, and body fastening protrusion 200. Further, the rail mounting mechanism may include: a first mounting protrusion 1302 extending from base 104, a first mounting bracket 1304, and a first mounting fastener 1306; as well as a second mounting protrusion 1308 extending from base 104, a second mounting bracket 1310, and a second mounting fastener 1312.

In an embodiment, junction box 1300 may be positioned on a mounting rail R such that first mounting protrusion 1302 and second mounting protrusion 1308 rest upon the top side of a mounting rail R and rest against a first side surface of the mounting rail R. In an embodiment, first mounting bracket 1304 and second mounting bracket 1310 may be configured to engage with a second side of the mounting rail R opposite base 104. In an embodiment, first mounting bracket 1304 and second mounting bracket 1310 are configured to receive first mounting fastener 1306 and second mounting fastener 1312, respectively.

For example, junction box 1300 may be positioned on a mounting rail such that first mounting protrusion 1302 and second mounting protrusion 1308 may include one or more laterally extending wings (i.e., opposing flanges), and may rest upon the top surface of mounting rail R and rest against a first side surface of the mounting rail R. In the example, first mounting bracket 1304 and second mounting bracket 1310 may be positioned on the side surface of the mounting rail R opposite junction box 1300 or such that a respective body portion of the first mounting bracket 1304 and second mounting bracket 1310, fits within the channel that extends along the rail. In an embodiment, first mounting fastener 1306 and second mounting fastener 1312 pass through respective apertures through a flange extending upward of the first mounting bracket 1304 and a flange extending upward of the second mounting bracket 1310, respectively. In the example, rotating first mounting fastener 1306 and second mounting fastener 1312 causes first mounting bracket 1304 and second mounting bracket 1310, respectively, to draw closer to first mounting protrusion 1302 and second mounting protrusion 1308. In the embodiment, first mounting bracket 1304 and second mounting bracket 1310 may be tightened such that junction box 1300 is fixed to mounting rail R.

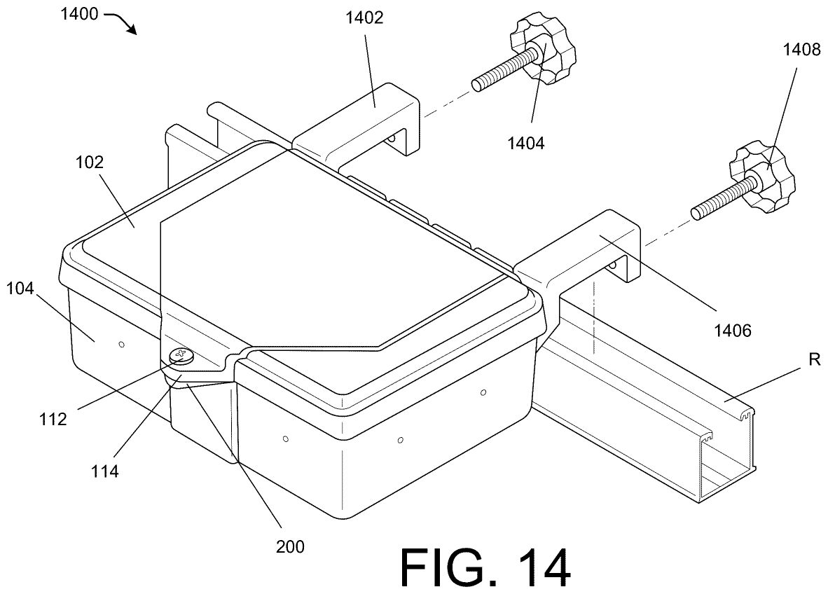

FIG. 14 illustrates a top, front-side-looking perspective view of a rail-mountable junction box (“junction box 1400”) with another clamping mechanism, attached to a rail, according to an embodiment of this disclosure. Junction box 1400 may include lid 102, base 104, lid fastener 112, lid fastening protrusion 114, body fastening protrusion 200, where the mounting mechanism for the junction box 1400 may include first mounting protrusion 1402 extending from base 104, first mounting knob 1404, second mounting protrusion 1406 extending from base 104, and second mounting knob 1408.

In an embodiment, first mounting protrusion 1402 and second mounting protrusion 1406 may be configured to resemble a u-shape (or a c-shape). In an embodiment, the opening between the arms of the u (or c) shape defining the respective bodies of first mounting protrusion 1402 and second mounting protrusion 1406 may be sized such that first mounting protrusion 1402 and second mounting protrusion 1406 may cover over a top side of the mounting rail R. In an embodiment, at least one arm of the u (or c) shaped arms of first mounting protrusion 1402 and second mounting protrusion 1406 may include a threaded aperture to receive first mounting knob 1404 and second mounting knob 1408, respectively. Thus, first mounting knob 1404 and second mounting knob 1408 may be inserted into the corresponding threaded aperture to apply tension to the mounting rail R such that junction box 1400 is in a fixed position against the mounting rail R.

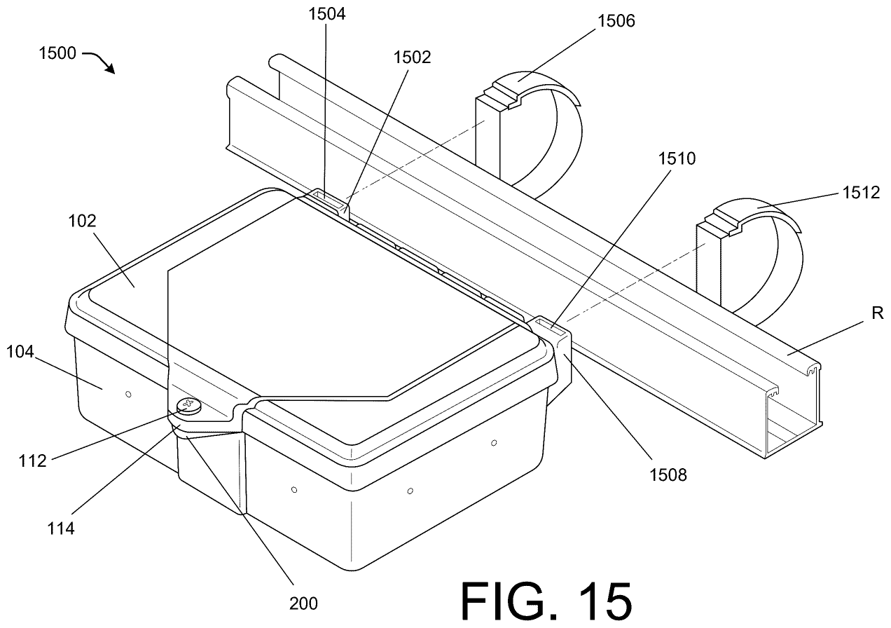

FIG. 15 illustrates a top, front-side-looking perspective view of a rail-mountable junction box (“junction box 1500”) with another alternative clamping mechanism, attached to a rail R, according to an embodiment of this disclosure. Junction box 1500 may include lid 102, base 104, lid fastener 112, lid fastening protrusion 114, and body fastening protrusion 200. The mounting mechanism may include a first mounting protrusion 1502 extending from base 104, a first mounting slot 1504, and a first mounting strap 1506; as well as a second mounting protrusion 1508 extending from base 104, a second mounting slot 1510, and a second mounting strap 1512.

In an embodiment, first mounting strap 1506 and second mounting strap 1512 may be made of nylon, rubber, or any other suitable material. Additionally, first mounting strap 1506 and second mounting strap 1512 may be sized to any particular size or shape, as desired (i.e., each mounting strap may be configured to have a threshold width and thickness). Accordingly, it is understood that the first mounting slot 1504 and the second mounting slot 1510 may be configured to accommodate the first mounting strap 1506 and second mounting strap 1512, respectively, to pass therethrough for mounting the junction box 1500 to rail R.

In an embodiment, first mounting strap 1504 and second mounting strap 1508 pass through mounting protrusion 1502 and mounting protrusion 1506, respectively, and wrap around the mounting rail. In such embodiments, the first mounting strap 1506 and second mounting strap 1512 may be configured to be tightened on a side of the rail R opposite the junction box 1500 such that the junction box 1500 is fastened to the mounting rail R. It is understood that first mounting strap 1506 and second mounting strap 1512 may be configured to be fastened using a hook and loop system (e.g., Velcro, etc.), buckles, snaps, or any other suitable fastening method.

Although FIGS. 10-15 depict lid 102 as having a different hinge configuration, it is understood that the embodiments depicted in FIGS. 10-15 may include the hinge configuration depicted in FIGS. 1-9.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A junction box comprising:
a body configured to mount to a solar panel mounting rail, and
a lid sized to seal against the body and to hingedly connect with the body when at a first angle that is less than a detaching angle,
wherein the lid is configured to separate from the body when at a second angle that is greater than the detaching angle.

2. The junction box of claim 1, the body including:
an enclosed bottom,
an open end opposite the enclosed bottom,
a front wall extending from the enclosed bottom to the open end,
a rear wall opposite the front wall extending from the enclosed bottom to the open end,
a first side wall extending from the enclosed bottom to the open end, the first side wall being attached to the front wall and the rear wall, and
a second side wall opposite the first side wall extending from the enclosed bottom to the open end, the second side wall being attached to the front wall and the rear wall.

3. The junction box of claim 1, the body including a mounting protrusion extending in a direction away from the body, the mounting protrusion including:
a first surface configured to planarly engage with a side of the solar panel mounting rail, and
a second surface configured to be positioned against a top surface of the solar panel mounting rail.

4. The junction box of claim 3, wherein the mounting protrusion is a first mounting protrusion, and
wherein the body further includes:
a second mounting protrusion extending in a direction away from the body, the second mounting protrusion including:
a first surface configured to planarly engage with the side of the solar panel mounting rail, and
a second surface configured to be positioned against the top surface of the solar panel mounting rail.

5. The junction box of claim 1, further comprising a clamp protrusion extending in a direction away from the body, the clamp protrusion including an aperture extending vertically through the clamp protrusion.

6. The junction box of claim 1, further comprising a clamp assembly, the clamp assembly, including:
an upper portion configured to attach to the body,
a lower portion configured to engage with the upper portion, and
a clamp fastener configured to connect the upper portion to the lower portion such that, via rotational movement of the clamp fastener within the upper portion and the lower portion, a distance between the upper portion and the lower portion is adjustable to accommodate a height of the solar panel mounting rail.

7. A junction box mounting system, comprising:
a junction box including:
a body configured to be mounted to a mounting rail, the body including:
an enclosed bottom,
an open end opposite the enclosed bottom,
a front wall extending from the enclosed bottom to the open end,
a rear wall opposite the front wall extending from the enclosed bottom to the open end,
a first side wall extending from the enclosed bottom to the open end, the first side wall being attached to the front wall and the rear wall,
a second side wall opposite the first side wall extending from the enclosed bottom to the open end, the second side wall being attached to the front wall and the rear wall,
a rail mount extending from an outside surface of the rear wall;
a lid shaped to be seated against a top surface of the body; and
an attachment device configured to secure the junction box to the mounting rail.

8. The junction box mounting system of claim 7, wherein the rail mount includes:
a first protrusion extending from an outside surface of the rear wall adjacent to the first side wall,
a second protrusion extending from the outside surface of the rear wall adjacent to the second side wall, and
a third protrusion extending the outside surface of the rear wall adjacent to the first side wall and the second side wall.

9. The junction box mounting system of claim 7, wherein the lid includes a lid hinge protrusion extending in a direction away from the lid, the lid hinge protrusion configured to engage with a body hinge protrusion, and the lid hinge protrusion including:
an upper hinge tab, and
a lower hinge tab defining a hinge cavity in connection with the upper hinge tab, the hinge cavity being configured to receive a portion of the body hinge protrusion.

10. The junction box mounting system of claim 9, wherein:
the lid hinge protrusion is a first lid hinge protrusion,
the upper hinge tab is a first upper hinge tab,
the lower hinge tab is a first lower hinge tab,
the hinge cavity is a first hinge cavity, and
the junction box mounting system further includes:
a second hinge protrusion extending in a direction away from the lid, the second hinge protrusion configured to engage with a second body hinge protrusion, and the second hinge protrusion including:
a second upper hinge tab, and
a second lower hinge tab defining a second hinge cavity in connection with the second upper hinge tab, the second hinge cavity being configured to receive a second portion of the second body hinge protrusion.

11. The junction box mounting system of claim 7, wherein the attachment device includes:
an upper portion configured to planarly engage with a top surface, a front surface, and a bottom surface of a the rail mount,
a lower portion configured to planarly engage with the outside surface of the rear wall and a rear surface of the rail mount, and
a clamp fastener configured to be displaced through the upper portion, the rail mount, and the lower portion.

12. The junction box mounting system of claim 11, wherein the outside surface of the rear wall includes one or more alignments ribs extending in a direction away from the body.

13. The junction box mounting system of claim 7, wherein:
the body further includes:
a body fastening protrusion extending from an outside surface of the front wall adjacent to the open end in a direction away from the body, and
a fourth aperture, and
the lid further includes a lid fastening protrusion extending from a front edge of the lid in a direction away from the lid and including a fifth aperture, the fifth aperture configured to align with the fourth aperture.

14. The junction box mounting system of claim 13, further comprising a lid fastener configured to be disposed between the fourth aperture and the fifth aperture.

15. A mountable junction box comprising:
a body configured to mount to a solar panel mounting rail,
a lid sized to seal against the body and to hingedly connect with the body when at a first angle that is less than a detaching angle,
wherein the lid is configured to separate from the body when at a second angle that is greater than the detaching angle, and
a clamp assembly configured to clamp onto the solar panel mounting rail, including:
an upper portion configured to attach to the body, the upper portion including a clamp body having a top portion and a bottom portion opposite the top portion,
a lower portion configured to engage with the upper portion, and
a clamp fastener configured to connect the upper portion to the lower portion such that, via rotational movement of the clamp fastener within the upper portion and the lower portion, a distance between the upper portion and the lower portion is adjustable to accommodate a height of the solar panel mounting rail.

16. The mountable junction box of claim 15, the clamp body including:
an inner surface configured to planarly engage with a front surface of a clamp protrusion extending from the body,
an outer surface configured to planarly engage with a side surface of the solar panel mounting rail,
a first tab extending from the top portion in a first direction perpendicular to the clamp body, the first tab configured to planarly engage with a top surface of a clamp protrusion and including a first aperture,
a second tab opposite the first tab extending from the bottom portion in a second direction perpendicular to the clamp body, the second tab configured to planarly engage with a bottom surface of the clamp protrusion and including a second aperture that is configured to align with the first aperture, and
a third tab extending from the clamp body in a third direction opposite the first direction, the third tab configured to be positioned against a top surface of the solar panel mounting rail.

17. The mountable junction box of claim 16, the lower portion including:
a first tab, including:
an outside surface configured to planarly engage with the body, and
an inside surface configured to planarly engage with a rear surface of the clamp protrusion, and
a second tab having extending from a bottom section of the first tab in a direction away from the first tab, the second tab having a surface configured to planarly engage with a bottom surface of the solar panel mounting rail and a third aperture that is configured to align with the first aperture and the second aperture.

18. The mountable junction box of claim 15, the body including:
an enclosed bottom,
an open end opposite the enclosed bottom,
a front wall extending from the enclosed bottom to the open end,
a rear wall opposite the front wall extending from the enclosed bottom to the open end,
a first side wall extending from the enclosed bottom to the open end, the first side wall being attached to the front wall and the rear wall,
a second side wall opposite the first side wall enclosed bottom to the open end, the second side wall being attached to the front wall and the rear wall,
a first protrusion extending from an outside surface of the rear wall adjacent to the first side wall,
a second protrusion extending from the outside surface of the rear wall adjacent to the second side wall, and
a third protrusion extending the outside surface of the rear wall adjacent to the first side wall and the second side wall,
a lid shaped to be seated against a top surface of the body, and
a clamp assembly configured to attach to the third protrusion.

19. The mountable junction box of claim 18, wherein the outside surface of the rear wall includes one or more alignments ribs extending in a direction away from the body.

20. The mountable junction box of claim 15, wherein the detaching angle is approximately twenty degrees.
